(19) United States
(12) Patent Application Publication
(10) Pub. No.: US 2017/0262852 A1
(43) Pub. Date: Sep. 14, 2017

(54) DATABASE MONITORING SYSTEM

(71) Applicant: Amadeus S.A.S., Biot (FR)

(72) Inventors: Cedric Florimond, Vallauris (FR); Thibaud Andrevon, Vallauris (FR); Mathieu Le Marier, Geneva (CH); Hanane El Kaoui, Antibes (FR)

(21) Appl. No.: 15/066,733

(22) Filed: Mar. 10, 2016

(51) Int. Cl. G06Q 20/40; G06Q 10/02; G06N 3/08

(52) U.S. Cl. CPC G06Q 20/4016; G06N 3/08; G06Q 10/02; G06Q 2220/00

(57) ABSTRACT

Systems, methods, and computer program products for monitoring a first database. A database monitoring system receives data indicative of change events relating to records in the first database, and stores the events in a second database. The database monitoring system further identifies records associated with fraudulent transactions, and defines a training set of transactions that includes the fraudulent transactions. A neural network is trained to detect patterns of events indicative of fraud using the training set and the corresponding events stored in the second database. In response to the trained neural network detecting a fraudulent pattern of events associated with an active database record, the database monitoring system analyzes the underlying transaction to determine if the transaction is fraudulent. A graphical display may be generated based on data extracted from the neural network, and may depict one or more vertices corresponding to events associated with fraudulent transactions.

### BACKGROUND

The invention generally relates to computers and computer systems and, in particular, to systems, methods, and computer program products that detect fraudulent manipulation of database records.

Payments for travel products are typically collected prior to the scheduled time of use of the products. Often, these payments are made by charging the cost of the travel products being purchased to a credit card account provided by the traveler, with the seller acting as the merchant. Credit card transactions typically comprise a two-stage process of authorization and settlement. At the time of the transaction, transaction information such as the purchase amount, identity of the merchant, credit card account number, and expiration date is transmitted from the merchant to an issuing bank. The issuing bank may then check the account to verify that the credit card is valid, and that the credit limit is sufficient to allow the transaction. If the bank approves the transaction, the merchant completes the transaction and issues a ticket to the traveler. To receive payment, the merchant may send a batch of approved authorizations to an “acquiring bank” at the close of the business day. The acquiring bank may then reconcile and transmit the authorizations to the issuing banks, typically via a card network or clearing house, and deposits funds in the merchant's account. Funds are then transferred from the issuing bank to the acquiring bank, and a bill sent to the cardholder by the issuing bank.

Unfortunately, credit cards are often used to fraudulently purchase airline tickets by fraudsters who utilize improperly obtained or stolen credit cards to make unauthorized purchases. When the true cardholder notices the unauthorized purchase, they may dispute the charge with the issuing bank. This typically results in a “chargeback” being issued to the merchant for the cost of the transaction. Chargebacks can be received up to several months after the transaction occurred, by which time the travel products have normally been used. Fraudulent credit card transactions thus cause substantial harm to merchants and travel product providers, who generally cannot recover the costs of the travel products.

Thus, improved systems, methods, and computer program products for analyzing transactions to detect fraud are needed to reduce the incidence of fraudulent charges and reduce losses incurred by merchants and travel product providers due to fraudulent purchases of travel products.

### SUMMARY

In an embodiment of the invention, a system is provided that includes one or more processors and a memory coupled to the processor. The memory includes program code that, when executed by the one or more processors, causes the system to detect a change to a travel record after an itinerary defined in the travel record has been booked, and in response to detecting the change, determine a pattern of changes to the travel record. The program code further causes the system to determine if the pattern matches a potentially fraudulent pattern, and in response to the pattern matching the potentially fraudulent pattern, flag the travel record as potentially fraudulent.

In another embodiment of the invention, a method is provided. The method includes detecting the change to the travel record after the itinerary defined in the travel record has been booked, and in response to detecting the change, determining the pattern of changes to the travel record. The method further includes determining if the pattern matches the potentially fraudulent pattern, and in response to the pattern matching the potentially fraudulent pattern, flagging the travel record as potentially fraudulent.

In another embodiment of the invention, a computer program product is provided that includes a non-transitory computer-readable storage medium including program code. The program code is configured, when executed by one or more processors, to cause the one or more processors to detect the change to the travel record after the itinerary defined in the travel record has been booked, and in response to detecting the change, determine the pattern of changes to the travel record. The program code further causes the one or more processors to determine if the pattern matches the potentially fraudulent pattern, and in response to the pattern matching the potentially fraudulent pattern, flag the travel record as potentially fraudulent.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary operating environment for a database monitoring system, the operating environment including a plurality of computing systems in communication via a network.

FIG. 2 is a diagrammatic view of an exemplary computing system of FIG. 1.

FIG. 3 is a schematic view of the database monitoring system of FIG. 1 showing a database monitoring engine.

FIG. 4 is a graphical view depicting a neural network that may be used by the database monitoring engine of FIG. 3 to detect database modification patterns indicative of fraud.

FIG. 5 is a graphical view of a simplified version of the neural network of FIG. 4.

FIG. 6 is a graphical view depicting an improvement in the ability of the neural network of FIG. 3 or 4 to detect patterns in a training sample.

FIG. 7 is a diagrammatic view depicting an effect of aggregating rules on a probability that a transaction is fraudulent.

FIG. 8 is a diagrammatic view of a graphical user interface that uses a plurality of vertices connected by edges to communicate patterns of fraud to a system user.

### DETAILED DESCRIPTION

Embodiments of the invention are directed to systems, methods, and computer program products that determine whether a previously completed transaction for a product is fraudulent. This determination may involve identifying a pattern of post-purchase changes to one or more database records that is indicative of fraud. Embodiments of the invention may be implemented by a database monitoring system comprising one or more networked computers or servers. The networked computers may include a Global Distribution System (GDS), and may provide processing and database functions for travel-related systems and modules that analyze database records to identify transactions that may be fraudulent. The database records may include, for example, travel records such as Passenger Name Records (PNRs), payment records, ticket documents, and/or customer profiles. If the database monitoring system detects suspicious post-booking reservation activity, the system may flag the transaction as potentially fraudulent, request additional fraud screening, and/or cancel the booking.

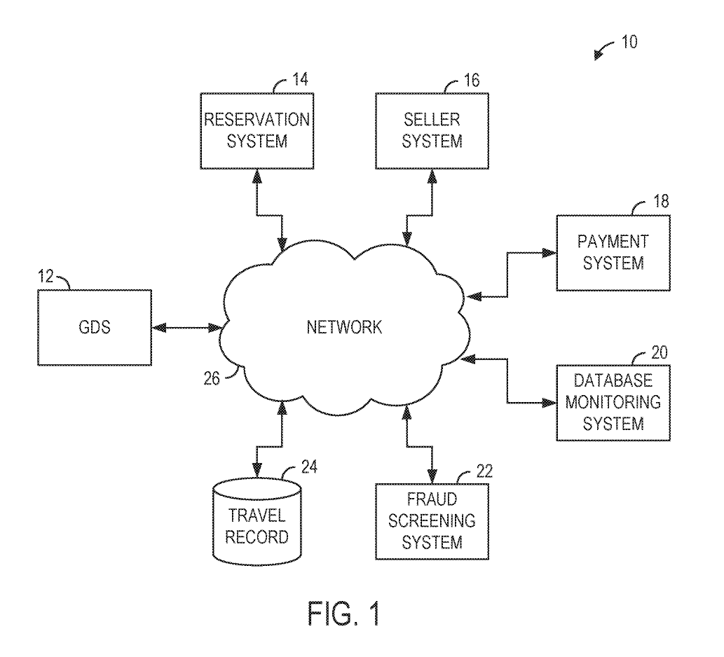

Referring now to FIG. 1, an operating environment 10 in accordance with an embodiment of the invention may include a Global Distribution System (GDS) 12, a reservation system 14, a seller system 16, a payment system 18, a database monitoring system 20, a fraud screening system 22, and a travel record database 24. Each of the GDS 12, reservation system 14, seller system 16, payment system 18, database monitoring system 20, fraud screening system 22, and travel record database 24 may communicate through a network 26. The reservation system 14 may include a Computer Reservation System (CRS) that enables the GDS 12 or seller system 16 to reserve and pay for airline tickets. The reservation system 14 may also interact with other reservation systems (not shown), either directly or through the GDS 12, to enable a validating carrier to sell tickets for seats provided by an operating carrier. The operating carrier may then bill the validating carrier for the products provided. Billing between sellers and travel product providers may be provided or otherwise facilitated by the payment system 18. The network 26 may include one or more private or public networks (e.g., the Internet) that enable the exchange of data between systems.

The GDS 12 may be configured to facilitate communication between the reservation system 14 and seller system 16 by enabling travel agents, validating carriers, or other sellers to book reservations on the reservation system 14 via the GDS 12. The GDS 12 may maintain links to a plurality of reservation systems via the network 26 that enable the GDS 12 to route reservation requests from the seller system 16 to a corresponding provider of the travel product being reserved. The seller system 16 may thereby book travel products from multiple product providers via a single connection to the GDS 12.

The payment system 18 may be configured to process forms of payment related to the purchase of products by the customer. The payment system 18 may be configured to exchange data with one or more bank systems (not shown), such as an issuing bank system and/or an acquiring bank system, to authorize payment and transfer funds between accounts. In the case of a purchase paid for at least in part by a credit or debit card, at the time of the transaction, the payment system 18 may transmit an authorization request to the issuing bank system, which may be determined from the issuer identification number of the card. In response to receiving the authorization request, the issuing bank system may verify the account is valid, and that the account has sufficient funds to cover the amount of the transaction.

The issuing bank system may then transmit an authorization response to the payment system 18 indicating that the transaction has been approved, declined, or that more information is required. If more information is required, the payment system 18 may request the fraud screening system 22 perform a security check on the form of payment. Once the transaction is complete, the seller system 16 may transmit data characterizing the transaction to the acquiring bank system. This data may be transmitted as part of a batch file at the end of a period of time, such as at the end of a business day. The acquiring bank system may then deposit funds into an account of the seller, and recover funds from the corresponding issuing banks of the credit cards used to purchase the travel products.

The fraud screening system 22 may be operated by an authentication service provider that provides predictive fraud screening. The predictive fraud screening may use one or more predictive models to detect fraud at the time of sale by applying the predictive models to transaction information. The transaction information may be transmitted to the fraud screening system by the seller system 16 and/or payment system 18, which may then wait for a reply from the fraud screening system 22 before completing the transaction. In some cases, the fraud screening system 22 may be operated by the issuing bank for the form of payment being used to purchase the travel product, or by a service provider contracted by the issuing bank.

The travel record database 24 may be provided by a stand-alone system, the GDS 12, or reservation system 14. The travel record database 24 may comprise a database of travel records, such as Passenger Name Records (PNRs). Each travel record may include one or more reservation records that contain itinerary and traveler information associated with one or more booked products. The one or more reservation records may include data defining an itinerary for a particular trip, passenger, or group of passengers. The defined itinerary may include travel products from multiple travel product providers, such as air carriers, hotels, car rental providers, or any other travel product provider. To facilitate locating the travel records in the travel record database 24, a record locator or other suitable identifier may be associated with each travel record.

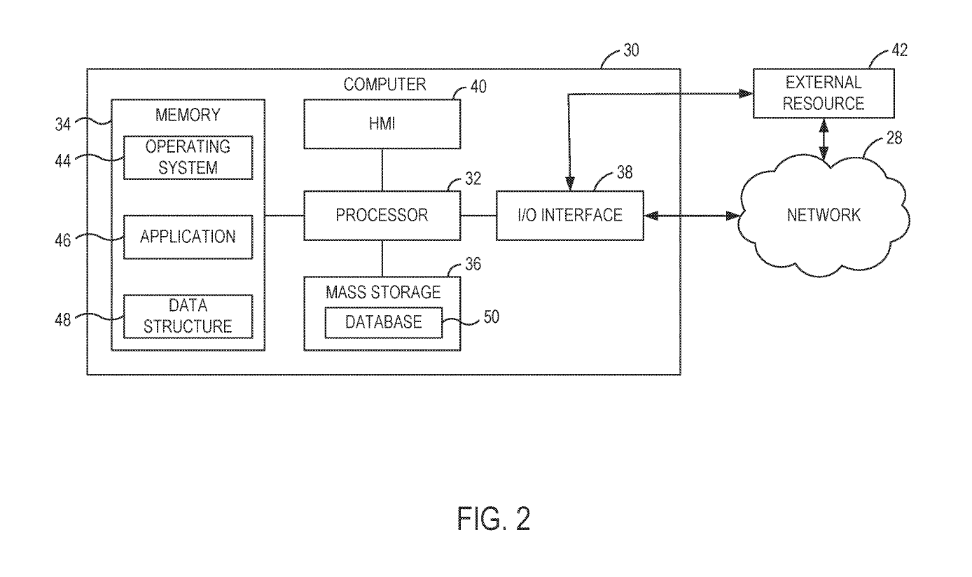

Referring now to FIG. 2, the GDS 12, reservation system 14, seller system 16, payment system 18, database monitoring system 20, fraud screening system 22, travel record database 24, and network 26 of operating environment 10 may be implemented on one or more computer devices or systems, such as exemplary computer 30. The computer 30 may include a processor 32, a memory 34, a mass storage memory device 36, an input/output (I/O) interface 38, and a Human Machine Interface (HMI) 40. The computer 30 may also be operatively coupled to one or more external resources 42 via the network 26 or I/O interface 38. External resources may include, but are not limited to, servers, databases, mass storage devices, peripheral devices, cloud-based network services, or any other suitable computer resource that may be used by the computer 30.

The processor 32 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in memory 34. Memory 34 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing data. The mass storage memory device 36 may include data storage devices such as a hard drive, optical drive, tape drive, volatile or non-volatile solid state device, or any other device capable of storing data.

The processor 32 may operate under the control of an operating system 44 that resides in memory 34. The operating system 44 may manage computer resources so that computer program code embodied as one or more computer software applications, such as an application 46 residing in memory 34, may have instructions executed by the processor 32. The processor 32 may also execute the application 46 directly, in which case the operating system 44 may be omitted. The one or more computer software applications may include a running instance of an application comprising a server, which may accept requests from, and provide responses to, one or more corresponding client applications. One or more data structures 48 may also reside in memory 34, and may be used by the processor 32, operating system 44, and/or application 46 to store and/or manipulate data.

The I/O interface 38 may provide a machine interface that operatively couples the processor 32 to other devices and systems, such as the network 26 or external resource 42. The application 46 may thereby work cooperatively with the network 26 or external resource 42 by communicating via the I/O interface 38 to provide the various features, functions, applications, processes, or modules comprising embodiments of the invention. The application 46 may also have program code that is executed by one or more external resources 42, or otherwise rely on functions or signals provided by other system or network components external to the computer 30. Indeed, given the nearly endless hardware and software configurations possible, it should be understood that embodiments of the invention may include applications that are located externally to the computer 30, distributed among multiple computers or other external resources 42, or provided by computing resources (hardware and software) that are provided as a service over the network 26, such as a cloud computing service.

The HMI 40 may be operatively coupled to the processor 32 of computer 30 to enable a user to interact directly with the computer 30. The HMI 40 may include video or alphanumeric displays, a touch screen, a speaker, and/or any other suitable audio and visual indicators capable of providing data to the user. The HMI 40 may also include input devices and controls such as an alphanumeric keyboard, a pointing device, keypads, pushbuttons, control knobs, microphones, etc., capable of accepting commands or input from the user and transmitting the entered input to the processor 32.

A database 50 may reside on the mass storage memory device 36, and may be used to collect and organize data used by the various systems and modules described herein. The database 50 may include data and supporting data structures that store and organize the data. In particular, the database 50 may be arranged with any database organization or structure including, but not limited to, a relational database, a hierarchical database, a network database, an object-oriented database, or combinations thereof.

A database management system in the form of a computer software application executing as instructions on the processor 32 may be used to access data stored in records of the database 50 in response to a query. The query may be dynamically determined and executed by the operating system 44, other applications 46, or one or more modules. Although embodiments of the invention may be described herein using relational, hierarchical, network, object-oriented, or other database terminology in specific instances, it should be understood that embodiments of the invention may use any suitable database management model, and are not limited to any particular type of database.

The fraud screening system 22 may attempt to prevent payment fraud by evaluating a risk of fraud at payment time, and deny the card if the risk of fraud is too high. However, even with pre-sale fraud screening, the rate of fraud may be greater than zero, and may typically be 10% or more. In order to circumvent the fraud screening system 22, fraudsters may create a purchase context that lacks indicators for fraud at the time of payment. The fraudster may then modify the reservation at a later time to perpetrate their fraud, such as by rebooking to a cheaper flight and pocketing the difference. A fraudster may perform this type of fraud by purchasing a ticket for a flight using a stolen credit card, and later requesting a refund on a credit card belonging to the fraudster. In this case, the transaction may avoid detection by the fraud screening system 22 based on the use of the fraudster's card since fraud screenings are typically not performed on a ticket refund.

Another way a fraudster may avoid detection by the fraud screening system 22 is by having the flight ticketed in the name of the cardholder of the stolen card at the time of booking. Pre-purchase fraud screening systems that treat mismatched passenger and cardholder names as an indicator of potential fraud may thereby be spoofed into allowing the transaction. After payment is made using the stolen credit card, the fraudster may change the name on the ticket to the name of the person who will actually be using the ticket.

Products may be available with different classes of service, with some classes of service subject to more lenient fraud screening rules than another classes of service. To take advantage of these differences, fraudsters may book a flight in one class of service so that the fraud screening system 22 applies the more lenient screening rules for that class, then after payment has been accepted, change the class of service to another class of service. Rules for fraud screening may be more lenient for some classes of service than other classes of service because rejecting the sale of the ticket represents a larger loss of revenue for the class having the more lenient rules. For example, a fraudster may book a ticket in business class, and once the ticket has been booked, rebook the ticket in economy class in exchange for the business class ticket. Since the price of an economy class ticket is normally lower than a business class ticket on the same flight, credit card payments may not be required. As a result, fraud screening will typically not be applied to the exchange of a business class ticket for an economy class ticket.

Another method that may be used to avoid flagging of a transaction by the fraud screening system 22 is to purchase a ticket using a frequent flier card number. Fraud screening rules may be more lenient for frequent fliers if frequent fliers are considered to be more trustworthy and/or valuable than regular customers by the carrier. In addition, third party fraud screening providers typically cannot check if a frequent flier card is valid, or if the name on the frequent flier card matches the name on the credit card. The fraudster may buy and pay for the flight with the stolen credit card, then delete the frequent flier card after payment has been made.

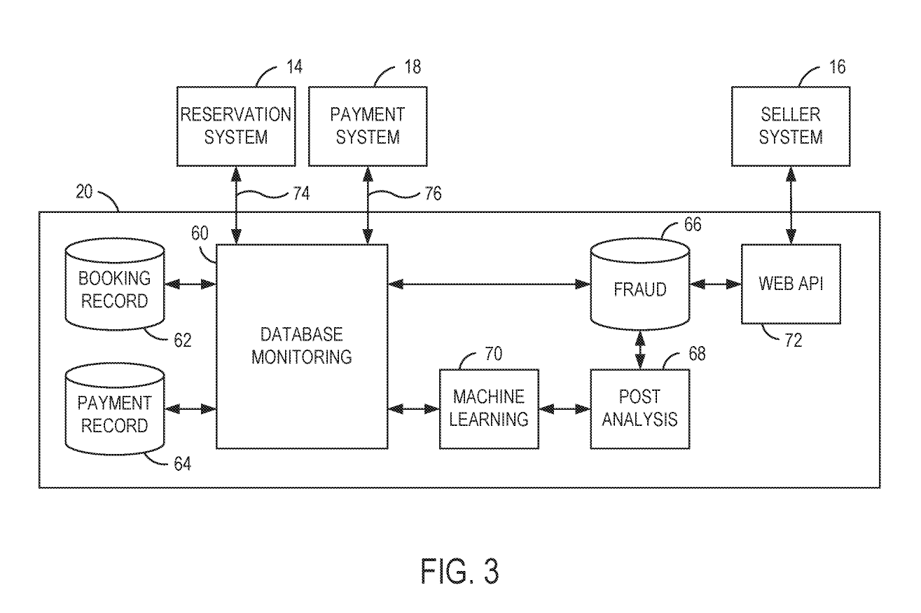

Referring now to FIG. 3, the database monitoring system 20 may include a database monitoring engine 60, a booking record database 62, a payment record database 64, a fraud database 66, a post analysis engine 68, a machine learning engine 70, and an Application Programming Interface (API) 72. The fraud database 66 may comprise a database of known fraudulent patterns. The API 72 may be, for example, a web API that enables users to access the database monitoring system 20 from external systems, such as the seller system 16 or other user system, using an access application, such as a web browser. The database monitoring engine 60 may receive a booking record feed 74 from the reservation system 14, and a payment record feed 76 from the payment system 18. In an embodiment of the invention, one or more of the reservation system 14, payment system 18, and database monitoring system 20 may be hosted or otherwise provided by the GDS 12.

The database monitoring engine 60 may store booking records received on the booking record feed 74 in the booking record database 62, and payment records received on the payment record feed 76 in the payment record database 64. The booking record database 62 and payment record database 64 may provide historical databases of payments and travel record events that can be used by the database monitoring engine 60 to predict fraud.

The post analysis engine 68 may manage the machine learning engine 70, which may comprise, for example, a neural network. The machine learning engine 70 may be configured to automatically detect (i.e. without human intervention) suspected fraudulent behavior based on booking activity that occurs after payment has been made. The post analysis engine 68 may also provide patterns of booking behavior after payment that appear to be related to fraudulent activity in a human readable form over the API 72.

The machine learning engine 70 may be configured to operate in a learning mode and a detection mode. Fraud detection by the machine learning engine 70 in the detection mode may be performed by a common traversal framework. This framework may allow different customers to define different typologies of fraud for different impacted areas. The framework may also automatically identify travel records which appear to be fraudulent using a machine learning algorithm, e.g., a neural network training algorithm. In addition to travel records, the fraud analysis topologies may analyze other types of records, such as payment records and user profiles, to further refine detection of fraudulent patterns.

While the machine learning engine 70 is in learning mode, the post analysis engine 68 may employ supervised learning to train the machine learning engine 70 using records for actual transactions known to be fraudulent. The known fraudulent transactions may be part of a training set of transactions stored in the fraud database 66. The known fraudulent transactions may be identified, for example, using chargeback reports produced by the seller system 16, payment system 18, or any other suitable system. For each transaction determined to be fraudulent, the database monitoring engine 60 may retrieve a related travel record (e.g., PNR) from the travel record database 24, and the history of the travel record from the booking record database 62 and/or payment record database 64. The history of the travel record may include a history of events that occurred over the life of the travel record, which may include the creation of the travel record, each subsequent change to the travel record, and the times at which each event occurred.

As part of the training process, the post analysis engine 68 may filter the history of events to generate a filtered history of events. This filtering may exclude events from the filtered history of events considered irrelevant to the detection of fraud (i.e., that are not considered to be helpful to a fraudster) such as the addition of a remark to the travel record. The filtered history of events and associated fraudulent transactions may be used to populate a learning set that is used to train the machine learning engine 70. The machine learning engine 70 may generate a fraud detection decision tree, and optimize the decision tree using the learning set. Training may be performed using a decision tree analysis, a random forest analysis, or a clustering analysis of the known fraudulent patterns. As an example of using decision tree analysis to filter events, the post analysis engine 68 may determine that in the case of a name change event followed by a name cancellation event prior to payment, only the name cancellation event should be retained.

Fraud detection based on post-sale modification of travel records may use a global classification of the fraudulent patterns. Fraudulent behavior alerts may then be varied in dependence on the market, with the definition of the market varying depending on the records being analyzed. For records relating to the distribution of tickets, markets may be based on the selling or ticketing office. For records generated by carrier systems, markets may be based on the airport ticket office, city ticket office, and/or the presence of the airline in the office. The database monitoring system 20 may include different selectable levels of reporting, such as periodic reporting, reporting upon alert, bottom-up reporting, and/or top-bottom broadcasting.

The fraudulent transaction data stored in the fraud database 66 may be used to provide sales channel scoring. To this end, the post analysis engine 68 may compute a score for each sales channel based on Key Performance Indicators (KPIs) for sales and fraud. Sales channel scoring may weigh and aggregate selected KPIs in order to determine a score for each sales channel in a given functional area. Sales channels may be moved to a higher or a lower score category according to the result of the computation. Movement from one score category to another may automatically trigger adjustment of downstream systems, such as point of sale, revenue integrity, Revenue Availability with Active Valuation (RAAV), pricing, and e-commerce based systems.

From a payment point of view, the database monitoring system 20 may identify fraudulent users who tweak transaction parameters to fool the fraud screening system 22 at payment time, and make later revisions to the reservation to complete the fraud. By analyzing the content of booking records and events together with payment records, the database monitoring engine 60 may detect a potentially fraudulent pattern of events, and call the fraud screening system 22 to re-analyze the transaction after payment. A report of potentially fraudulent patterns may be produced to alert merchants to suspicious behaviour, and to help improve security.

Events analyzed for suspicious patterns may include flight date changes. For example, changes to flight times made shortly after booking the flight (e.g., less than one day) may be indicative of fraud. Moreover, the probability of fraud may increase in inverse proportion to the amount of time between the time the flight was booked and the time the change request is made. Changing the flight time from its originally scheduled departure time (e.g., several days/weeks/months in the future) to a more immediate time (e.g., the same day as the change is requested) may also indicate fraud. In this case, the probability of fraud may be related to the size of the change, with large changes in departure time indicating a higher probability of fraud than shorter changes in departure time. Changes that move the departure time to shortly after the time the change is requested (e.g., departure on the same day as the change is requested) may also provide an indication of fraud, with the probability of fraud increasing in inverse proportion to the amount of time between the time the change request is made and the requested departure time. In response to detecting a suspicious flight date change, the database monitoring system 20 may call the fraud screening system 22 to re-screen the transaction using new values for the booking and departure dates.

The machine learning engine 70 may analyze travel record changes using a neural network including a plurality of artificial neurons, or “nodes” that are interconnected in a manner analogous to a biological neural network made up of neurons and synapses. The nodes may be arranged in a plurality of layers each comprising one or more nodes, with the nodes in each layer connected to one or more nodes in adjacent layers by weighted links.

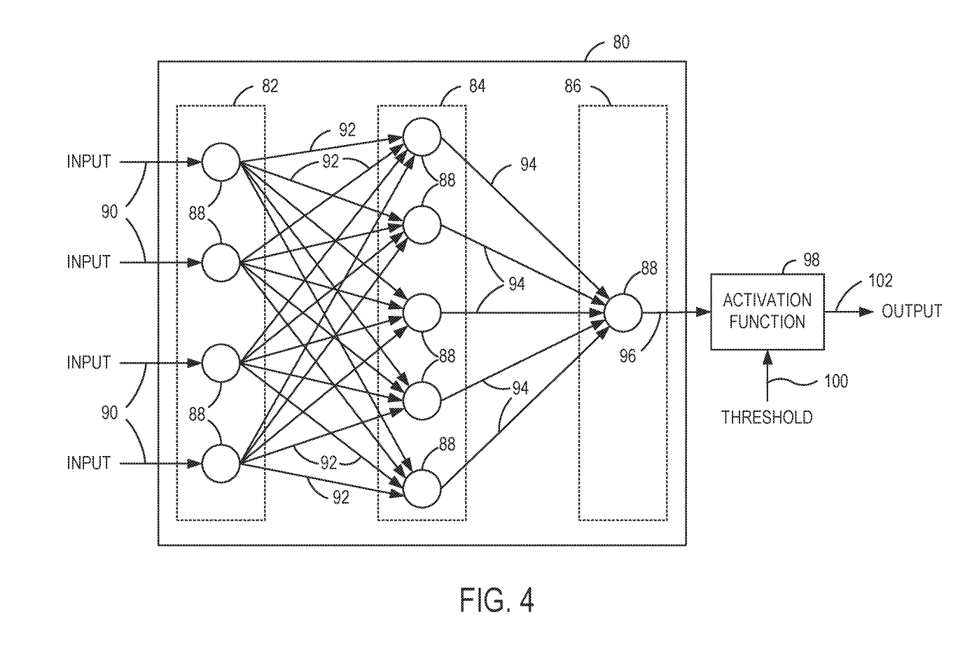

FIG. 4 depicts an exemplary neural network 80 having an input layer 82, a hidden layer 84, and an output layer 86, with each layer comprising one or more nodes 88. The input layer 82 may receive a plurality of input signals 90 (e.g., four) from outside the neural network 80. The input layer 82 may couple the received signals to the hidden layer 84 over weighted links 92, with each node 88 in the hidden layer 84 summing the weighted signals received from the nodes 88 of input layer 82.

The summed signals from each node 88 of hidden layer 84 may be further coupled to each node 88 of output layer 86 over weighted links 94 to provide at least one output signal 96. The output signal 96 may be further coupled to an activation function 98, which may compare the output signal 96 to a threshold 100, and output an output signal 102 having a logical value=0 (i.e., “true”) or a logical value=1 (i.e., “false”) depending on the value of the output signal 96 relative to the threshold 100.

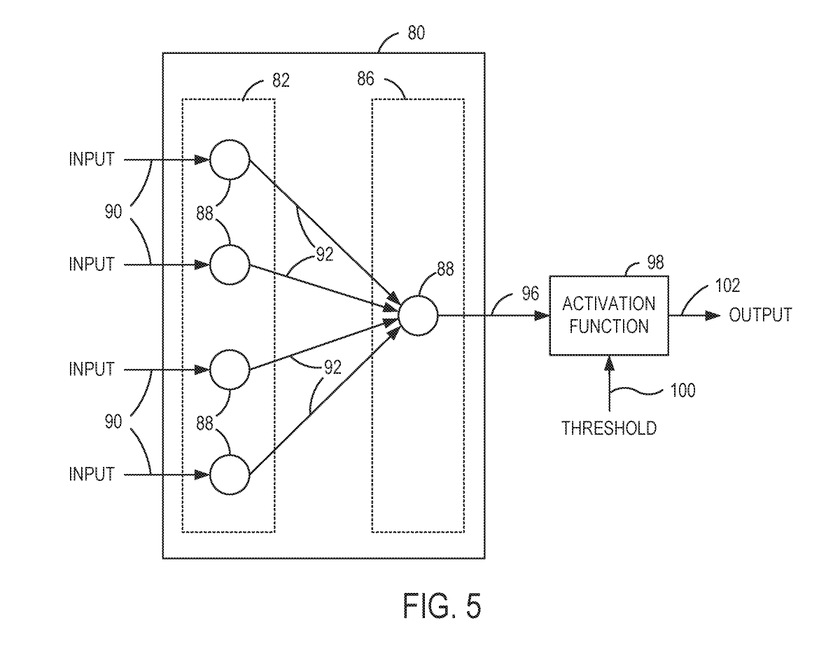

Although illustrated as having three layers for exemplary purposes, the neural network 80 may have more than three layers (e.g., by adding additional hidden layers) or fewer than three layers. For example, FIG. 5 depicts an embodiment of neural network 80 having the nodes 88 of input layer 82 coupled directly to the node 88 of output layer 86. For neural network 80, if the weighted sum of the input signals 90 is above the threshold 100, the output signal 102 of activation function 98 may be logic value 1. However, if the weighted sum of the input signals 90 is below the threshold 100, the output signal 102 of activation function 98 may be logic value 0.

The weights of the links 92, 94 connecting the nodes 88 of hidden layer 84 to the nodes 88 of input and output layers 82, 86 may be adjusted by training algorithms that optimize the output to provide known correct results (i.e., fraud=true/false) in response to the input parameters (e.g., name change event=true/false) that produced the known result. For example, the post analysis engine 68 may use a deep learning neural network algorithm to train the neural network 80.

The database monitoring engine 60 may use the machine learning engine 70 to recognize patterns and evaluate a probability that the recognized pattern is indicative of fraud. Because the machine learning engine 70 may effectively learn complex patterns autonomously, once trained, the machine learning engine 70 may operate as a “black-box” that predicts fraud based on the booking record and/or payment record feeds.

To configure the machine learning engine 70 to identify fraudulent patterns of booking, a custom neural network may be constructed using techniques such as pre-training by auto-encoding. This may be accomplished, for example, by analyzing fraud results for historical transactions that include transactions in which a chargeback was received (i.e., known fraudulent transactions), and transactions for which a chargeback was not received (i.e., known legitimate transactions). An exemplary historical set of samples may include a number of known fraudulent transactions (e.g., 4500) and a number of known legitimate transactions (e.g., 100,000). From this historical set of sample of transactions, a training set may be defined that includes a number of known fraudulent transactions (e.g., 4000), a number of known legitimate transactions (e.g., 8000), and a testing set including a number of transactions (e.g., 4000) randomly selected from the historical sample. The post analysis engine 68 may retrieve features from transactions to use as inputs to the neural network 80. These features may include general information such as the ip-based city or region, and may include a large number (e.g., 732) of binary variables.

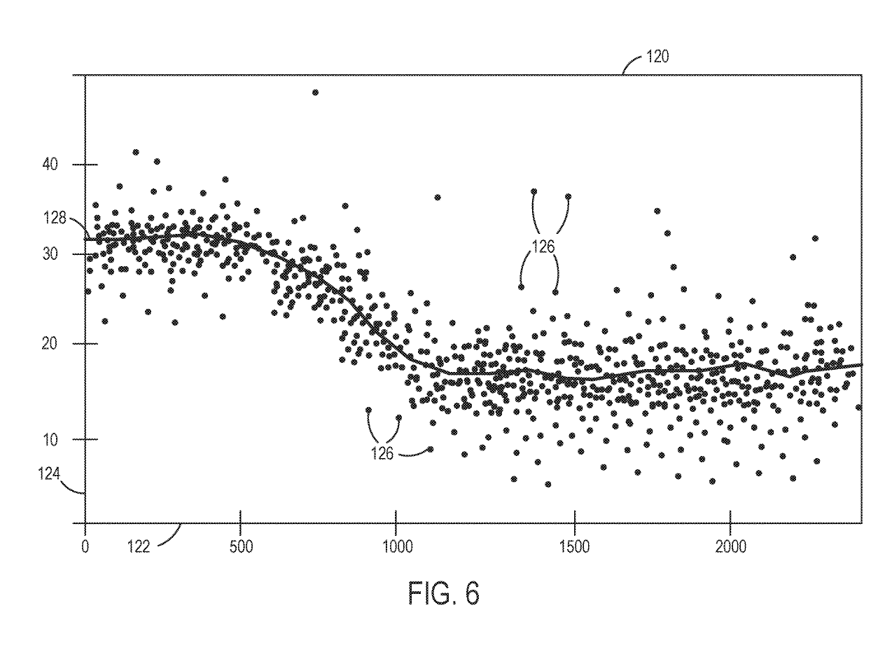

Referring now to FIG. 6, and for purposes of illustration only, an exemplary graph 120 includes a horizontal axis 122 corresponding to batch index, and a vertical axis 124 corresponding to a value of a cross-entropy error function. It should be understand that the scales of horizontal axis 122 and vertical axis 124 may be distorted in order to more clearly describe embodiments of the invention. The graph 120 includes a plurality of sample points 126 each representing a transaction in the sample, and a plot 128 representing a mean value of the cross-entropy error function. The neural network 80 may be trained by building random mini-batches of training data and letting the neural network 80 adjust itself to minimize the cross-entropy error. As can be seen by viewing graph 120, the trend of plot 128 moving left-to-right shows a decrease in the mean value of the cross-entropy function. This decrease may illustrate that the neural network 80 has learned how to solve roughly 50% of the total entropy (disparity) of the training data. A more complex network having larger numbers of nodes and levels, as well as better tuned training parameters, may provide improved results.

TABLE 1
NEURAL NETWORK PERFORMANCE

ACTUAL VALUES

| | | NON-FRAUD | FRAUD |
|---|---|---|---|
| MODEL | NON-FRAUD | 3360 | 70 |
| PREDICTION | FRAUD | 158 | 112 |

Table 1 depicts results of testing 4000 sample transactions including 3818 (3360+158) known non-fraudulent transactions, and 182 (70+112) known fraudulent transactions using an experimental neural network constructed as described above. The experimental neural network achieved an overall accuracy rate of 94.3% ((3660+112)/(4000)) in identifying whether a transaction was fraudulent or non-fraudulent. The neural network also achieved a false negative rate of 38.5% (70/(70+112)). Stated another way, the neural network detected 61.5% of the known fraudulent transactions in the sample. The false positive rate can be seen to be 4.14% (158/(3660+158)).

Because the neural network 80 operates as a kind of black-box, it may be difficult to extract information from the machine learning engine 70 in a human readable form. To provide users with information on how the machine learning engine 70 is detecting fraud, the post analysis engine 68 may generate a graphical display that illustrates relationships between travel record events and fraudulent transactions in the machine learning engine 70.

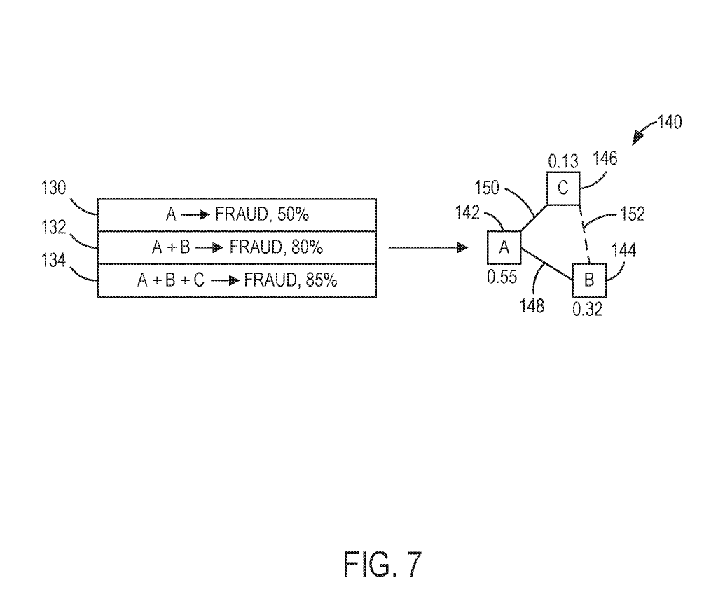

Referring to FIG. 7, a plurality of relationships 130, 132, 134 may be defined in the machine learning engine 70. Relationship 130 may associate the presence of condition A (e.g., a change of departure date on the same day the flight is booked) with a 50% probability of the transaction being fraudulent. Relationship 132 may associate the presence of conditions A and B (e.g., a change of departure date on the same day the flight is booked, and a change of name on the reservation) with an 80% probability of the transaction being fraudulent. Relationship 134 may associate the presence of conditions A, B, and C (e.g., a change of departure date on the same day the flight is booked, a change of name on the reservation, and a change of reservation from first class to coach) with an 85% probability of the transaction being fraudulent.

These relationships 130, 132, 134 may form a pattern that can be represented by a graph 140. Graph 140 may comprise a plurality of vertices 142, 144, 146 connected by edges 148, 150, 152. Each vertex 142, 144, 146 may represent a travel record entry or condition, and may have a weight corresponding to a correlation between the frequency the condition is present in the travel record history, and whether the corresponding transaction is fraudulent. The presence of an edge connecting a pair of vertices i and j may indicate that the conditions represented by the vertex pair (i, j) contribute to the probability of fraud in a cumulative or synergistic way when both conditions are present.

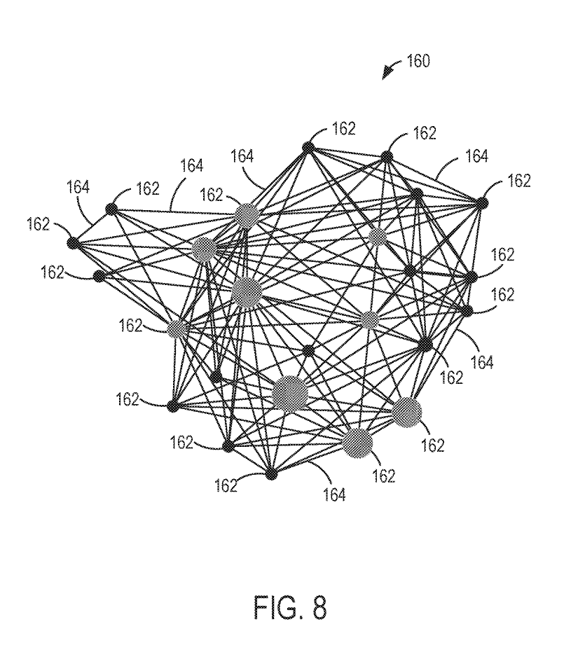

FIG. 8 depicts an exemplary graph 160, which may be a force-directed graph, that includes a plurality of vertices 162 interconnected by a plurality of edges 164. Each vertex 162 may represent a condition, such as a particular entry in a data field of a travel record, and each edge 164 may represent a relation between the conditions represented by the connected vertices. Exemplary travel record entries that may be represented by a vertex 162 may include, but are not limited to:

amount=[378, 763]

amount=[763, 74203]

ccblob_RiskManagementData_PaymentInfo_FareAmount=[375, 755]

ccblob_RiskManagementData_PaymentInfo_FareAmount=[755, 74203]

ccblob_RiskManagementData_PaymentInfo_FeeValue=0.00

ccblob_RiskManagementData_PaymentInfo_FeeValue=[0.82, 4319.85]

ccblob_RiskManagementData_Result=False

ccblob_StringBom_Original_Provider=BN

ccblob_StringBom_Original_Provider=BP

ccblob_StringBom_rm_response=0K

recloc_InternetIndicator=N

root_xmlblob_aysResultCode=none

root_xmlblob_aysResultCode=U

root_xmlblob_cvvOrgCode=none

root_xmlblob_cvvResultCode=none

root_xmlblob_dslink=VIDSSSL

root_xmlblob_isfAmount=[88.8, 209.0]

root_xmlblob_isfAmount=[0.0, 88.8]

root_xmlblob_isnAmount=[144, 9564]

root_xmlblob_nbinstal=[3, 6]

root_xmlblob_nbinstal=[0, 3]

root_xmlblob_nbinstal=[6, 12]

root_xmlblob_paymentmethod=41

root_xmlblob_taxamount=0.00

root_xmlblob_taxamount=[1.48, 1934.83]

Each vertex 162 may have a graphical characteristic, such as a diameter, shape, or color, that indicates a characteristic of the condition represented, such as a “mass” or weight of the condition with regard to fraudulent transactions. For example, vertices having a relatively larger mass than other vertices may be displayed as a circle having a larger diameter than the other vertices.

The mass μ(R) of a vertex representing a condition R for a non-oriented graph having N local maxima, or summits, may be determined using the following equation:

μ(R)=P(F|R)Supp(R) Eqn. 1

where Supp(R) returns the set of vertices for which R is non-zero, and P(F|R) returns a probability of fraud for transactions including R.

Aggregation on one summit may be determined using the following equation:

$$M ( {e}_{i} ) = \frac{1}{{\sum }_{r ∈ R} α ( r ) μ ( r )} {\sum }_{{r ∈ R}_{{e}_{i} ∈ R}} α ( r ) \frac{μ ( r )}{‖ r ‖} \qquad Eqn . 2$$

where α(r) provides an aggregation function, which may be unity in some embodiments, r is an edge vector, and eᵢ is the vertex for which the mass is being aggregated.

The graph 160 may be generated from vertices and links that have been pruned so that graph 160 only displays the most relevant vertices. Pruning may be performed by the following equation:

$$σ ( {e}_{i} , {e}_{j} ) = {\sum }_{R} {δ}_{i , R} {δ}_{j , R}$$

where σ(eᵢ,eⱼ) is the aggregated weight of the aggregated vertices eᵢ and eⱼ, and δ_{(i,R)} and δ_{(j,R)} are ideal lengths of edges connecting nodes i and j without using a separate repulsive force.

Upon inspection of graph 160, a user may determine that the conditions represented by larger vertices are associated with a relatively large number of chargebacks. For example, one or more connected large vertices may reveal that a disproportionate number of fraudulent transactions include a travel record defining an itinerary purchased through an off-line channel, without a Card Verification Value (CVV) number, and without address verification. This may, for example, allow the user to quickly identify a strategy being employed by fraudsters. Other combinations of conditions, such as the identity of the Internet provider, ticketing offices, types of credit cards, origination and destination locations, airports, as well as the frequency with which combinations appear over different time periods may thereby provide the user with early indications of a fraud attack.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of data, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired data and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer-readable medium produce an article of manufacture including instructions that implement the functions, acts, and/or operations specified in the flow-charts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flow-charts, sequence diagrams, and/or block diagrams.

In certain alternative embodiments, the functions, acts, and/or operations specified in the flow-charts, sequence diagrams, and/or block diagrams may be re-ordered, processed serially, and/or processed concurrently consistent with embodiments of the invention. Moreover, any of the flow-charts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, actions, steps, operations, elements, and/or components, but do not preclude the presence or addition of one or more other features, integers, actions, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

1. A system comprising:
one or more processors; and
a memory in communication with the one or more processors, the memory storing program code configured to, when executed by the one or more processors, cause the system to:
detect a change to a first travel record after a first itinerary defined in the first travel record has been booked;
in response to detecting the change, determine a first pattern of changes to the first travel record;
determine if the first pattern matches a potentially fraudulent pattern; and
in response to the first pattern matching the potentially fraudulent pattern, flag the first travel record as potentially fraudulent.

2. The system of claim 1 wherein the program code is further configured to cause the system to:
in response to the first travel record being flagged as potentially fraudulent, transmit data that characterizes a transaction to purchase the first itinerary to a fraud screening system.

3. The system of claim 1 wherein the program code is further configured to cause the system to:
receive a chargeback associated with a second itinerary;
identify a second travel record that defines the second itinerary;
retrieve a history of events of the second travel record;
determine a second pattern of changes to the second travel record based at least in part on the history of events; and
storing the second pattern in a database of known fraudulent patterns.

4. The system of claim 3 wherein the program code is further configured to cause the system to determine if the first pattern matches the potentially fraudulent pattern by:
comparing the first pattern to one or more known fraudulent patterns; and
defining the first pattern as matching the potentially fraudulent pattern in response to the first pattern matching one or more of the known fraudulent patterns.

5. The system of claim 3 wherein the program code is further configured to cause the system to:
train an algorithm to detect potentially fraudulent patterns using the known fraudulent patterns in the database of known fraudulent patterns.

6. The system of claim 5 wherein the program code causes the system to train the algorithm by:
filtering the history of events to remove events classified as irrelevant to a fraud analysis; and
using the filtered history of events to train the algorithm.

7. The system of claim 1 wherein the change to the first travel record is a date of use of a booked product, an identity of a passenger, a class of service of the booked product, a refund of a ticket, a rebooking of the ticket, or an exchange of the ticket.

8. A method comprising:
detecting, by a server, a change to a first travel record after a first itinerary defined in the first travel record has been booked;
in response to detecting the change, determining, by the server, a first pattern of changes to the first travel record;
determining, by the server, if the first pattern matches a potentially fraudulent pattern; and
in response to the first pattern matching the potentially fraudulent pattern, flagging the first travel record as potentially fraudulent.

9. The method of claim 8 further comprising:
in response to the first travel record being flagged as potentially fraudulent, transmitting data that characterizes a transaction to purchase the first itinerary to a fraud screening system.

10. The method of claim 9 wherein the transaction is characterized at least in part by the first pattern.

11. The method of claim 9 further comprising:
in response to the fraud screening system indicating the transaction is fraudulent, cancelling the booking of the first itinerary.

12. The method of claim 8 further comprising:
receiving a chargeback associated with a second itinerary;
identifying a second travel record that defines the second itinerary;
retrieving a history of events of the second travel record;
determining a second pattern of changes to the second travel record based on the history of events; and
storing the second pattern in a database of known fraudulent patterns.

13. The method of claim 12 wherein determining if the first pattern matches the potentially fraudulent pattern comprises:
comparing the first pattern to one or more known fraudulent patterns; and
defining the first pattern as matching the potentially fraudulent pattern in response to the first pattern matching one or more of the known fraudulent patterns.

14. The method of claim 12 further comprising:
training an algorithm to detect potentially fraudulent patterns using the known fraudulent patterns in the database of known fraudulent patterns.

15. The method of claim 14 wherein training the algorithm comprises:
filtering the history of events to remove events classified as irrelevant to a fraud analysis; and
using the filtered history of events to train the algorithm.

16. The method of claim 14 wherein the algorithm is based on a decision tree analysis, a random forest analysis, or a clustering analysis of the known fraudulent patterns.

17. The method of claim 8 further comprising:
in response to the first pattern being flagged as potentially fraudulent, adding the first pattern to a report of potentially fraudulent patterns; and
transmitting the report of potentially fraudulent patterns to a user system.

18. The method of claim 8 wherein the change to the first travel record is a date of use of a booked product, an identity of a passenger, a class of service of the booked product, a refund of a ticket, a rebooking of the ticket, or an exchange of the ticket.

19. The method of claim 8 wherein the first pattern includes changes since the first travel record was created in a database of travel records.

20. A computer program product comprising:
a non-transitory computer-readable storage medium; and
program code stored on the non-transitory computer-readable storage medium that, when executed by one or more processors, causes the one or more processors to:
detect a change to a first travel record after a first itinerary defined in the first travel record has been booked;
in response to detecting the change, determine a first pattern of changes to the first travel record;
determine if the first pattern matches a potentially fraudulent pattern; and
in response to the first pattern matching the potentially fraudulent pattern, flag the first travel record as potentially fraudulent.
